(19) United States
(12) Patent Application Publication
(10) Pub. No.: US 2009/0076716 A1
(43) Pub. Date: Mar. 19, 2009

(54) CHARACTERISTIC NUMBER METHOD FOR ENGINE REAL-TIME DIAGNOSTICS APPLICATION

(75) Inventor: Zhiping Han, La Salle (CA)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation, Detroit, MI (US)

(21) Appl. No.: 11/857,495

(22) Filed: Sep. 19, 2007

(51) Int. Cl. G06F 19/00

(52) U.S. Cl. 701/115

(57) ABSTRACT

A method of internal combustion engine operation that include real time engine diagnostics to detect hardware malfunctions that combines the signals for two or more sensors to detect the severity of a hardware malfunction.

### BACKGROUND OF THE INVENTION

In general, hardware caused malfunctions in engine control are detected by checking directly the readings from physical sensors. As an example, the present technology used at DDC to detect an EGR loop malfunction is done by a physical EGR mass flow rate measurement sensor inserted inline in the EGR loop. The measured EGR mass flow rate is compared to the targeted value in the map stored in control software memory. The difference is used to judge if the EGR flow is insufficient or over flowing, so to send a fault message to the engine's control system for proper actions in case the difference exceeds certain thresholds.

The EGR engine is equipped with a valve which is used to adjust the EGR flow rate by changing its' flow area. The valve's position is dynamically adjusted during engine's operation under various conditions. One of the mechanical failures this valve may have is that the valve gets stuck in a certain position. When the valve gets stuck in a position, depending on what the position is, it may cause either inefficient EGR flow or excessive EGR flow. Currently, the above mentioned direct EGR flow rate measurement technique can detect a fully or partially stuck closed EGR valve with insufficient flow or a leaking EGR loop anywhere upstream of the EGR measurement sensor along the EGR loop. The current technique however, is neither able to detect the fully stuck open valve position, nor the EGR loop leakage anywhere downstream of the measurement sensor. After all, the EGR flow measurement technique adds to the engine a good amount of manufacturing cost.

1. Field of the Invention

The present invention relates to a method of engine operation that includes a real-time engine diagnostics function to detect malfunctions caused by hardware failures that may cause the engine, or it components, to be damaged, have their performance downgraded, or render the engine exhaust emissions non-compliant with legislative requirements.

The present invention further relates to a method of engine operation that includes real-time engine diagnostics to detect malfunction caused by hardware failures without the need for additional physical sensors.

2. Description of the Related Art

Schmid, et al. U.S. Pat. No. 6,848,300 discloses a method for the diagnosis of an exhaust turbocharger for an internal combustion engine. The method includes at least one value which characterizes the load on the exhaust turbocharger which is determined when compared with the reference value. An event signal is generated in the event the reference value is exceeded by the determined value. The wear characteristic number which characterizes the alternating load on the exhaust turbochargers is formed by the addition of load signals; in each case one change signal is generated whenever the charger speed of the exhaust turbocharger exceeds a maximum.

The wear characteristic number is formed by the addition of individual load signals which are in each case generated in the event of the charger speed of the exhaust turbocharger exceeding the maximum. The wear characteristic number Vᵢ is calculated or updated by adding the current load signal to a previous signal in accordance with the following relationship:

Vᵢ=Vᵢ−1+w_{J′}

wherein
i characterizes values for the current method of operation;
the index i−1 characterizes values from a method of operation; and
w_{J} is the current load signal.

Lewis, Jr., et al., U.S. Pat. No. 6,256,992 discloses a system and method of managing the operation of a turbocharger and is responsible for controlling the turbocharger to cause a desired air mass flow to be provided to the engine and for protecting the turbocharger from excessive shaft speed and excessive turbo inlet temperature. The protection modes have higher priority than the performance control. First, a turbocharger shaft speed is checked against a programmable limit and the turbocharger is adjusted to bring the speed under control if its speed exceeds the programmable limit. If the speed is not above the programmable limit, the turbine inlet temperatures chart against the second programmable limit. If the turbocharger inlet temperature is above the predetermined limited, the turbocharger is adjusted to bring the inlet temperature under control. If after either of these adjustments are made, the predetermined limits are still exceeded by the turbocharger, the system invokes a derating of the fueling to the engine in order to protect the turbocharger. If no other limits have been exceeded, then the system operates the turbocharger to provide the desired air mass flow to the engine in order to maximize engine performance.

Honold, et al., U.S. Pat. No. 6,250,145 discloses a method for operationally testing an exhaust gas turbocharger with a variable turbine geometry with a changeable adjustment that the effective turbine cross section, in which the actual values of operating quantities influencing the operational capability of the exhaust gas turbocharger are detected with comprise main quantities used for the decision of whether a fault is present in the exhaust gas turbocharger as well as auxiliary quantities which may describe a component of the exhaust gas turbocharger and are used for identifying the faults of this component. In a first step for the fault detection a quantity determining the engine's air supply is measured as the main quantity. In the second step at least one auxiliary quantity is measured for the fault identification and in the event of an unacceptable deviation of the actual auxiliary quantity value from the desire auxiliary quantity value, a fault signal is generated. The position of the adjusting element is measure as an auxiliary quantity by way of which adjusting element of the variable turbo geometry is adjustable.

In operation, when testing an exhaust gas turbocharger with variable turbine geometry, actual values are detected of operating quality which influenced the operational capability of the exhaust gas turbocharger in which comprised main quantities which are used for deciding whether a fault exists in the exhaust gas turbocharger, as well as auxiliary quantities which describe the component of the exhaust gas turbocharger and are used for identifying faults in this component. In a first step for fault detection, a quantity is measured as the main quantity which determines the engine air supply. In a second step, at least one auxiliary quantity is measured for the fault identification, and in the event of an unacceptable deviation of the actual auxiliary quantity value for the desired auxiliary quantity value, a fault signal is generated.

### BRIEF SUMMARY OF THE INVENTION

This present invention is a method to operate an electronically controlled internal combustion engine that comprises determining a “characteristic number” (CN), and comparing the CN with the stored threshold value to determine a sensed effect indicative of possible hardware failure. A CN is defined as a numerical parameter calculated from more than two of the output of selected sensors through a mathematical function structure as expressed below:

CN=f(sensor₁, sensor₂, . . . sensorₙ)

A different mathematical structure defines different CN depending on the application needs. The properly defined CN can then be used as or to replace a physical measurement sensor for engine diagnostic purposes like EMD (engine manufacturer diagnostics) or OBD (on board diagnostics). When the engine is running, the calculated CN is compared to the reference value stored in the map of control software memory in real time, if the difference exceeds a threshold, a fault message is sent out.

The important concept of the CN is that it usually does not provide a meaningful physical quantity, but often a relative value related to a physical phenomena. In other words, the CN is a method that uses the sensed “effect” to track back the possible “cause”. From the engine control point of view, not all malfunctions caused by hardware failures can be detected or measured directly, simply because of lacking a means of sensing them. Some malfunctions are directly measurable and detectable, but require specific physical sensors. The CN on the other hand, can provide a means to either sense the malfunctions for which no physical sensor exists in use on the engine, so to improve the protection to the engine; or replace the functionality of a physical sensor, to save the manufacturing costs.

When a malfunction occurs on an engine and causes a control parameter to deviate from the desired target or baseline value, even without a direct measurement sensor of that control parameter, certain other sensors' reading may be affected and show a difference as compared to the normal operating baseline readings at some operating points. But these same sensors may not show the difference at other operating points at the same time. The number of sensors showing or not showing the reading difference varies with the engine's operating conditions for the same hardware malfunction. Furthermore, some sensor's reading may go positive or negative direction change in difference referring to the baseline when operating condition changes. For a sensor, even its reading showing consistently only one direction change, the change can be caused by different reasons. If this single sensor is used to detect a hardware failure, it may give false fault. All these factors make it unreliable to use these relevant sensors' reading directly to obtain a clear picture if that specific control parameter has deviated from its target and a malfunction has occurred.

If part or all of the relevant sensors are mathematically grouped together in a proper way to form a single new parameter, the so called “characteristic number” or CN, then the CN can carry all the formation contributed by each individual sensor collectively at all operating times, and can paint a clear picture of what has happened.

### BRIEF DESCRIPTION OF THE DRAWINGS

FIG. 1 is a schematic representation of an internal combustion engine system and an electronic controller.

FIG. 2 is a graph representative of the impact of a stuck EGR valve on NOx emissions.

FIG. 3 is a graph representation of an IMP sensor impacted by a stuck EGR valve.

FIG. 4 is a graph representation of an IMT sensor impacted by a stuck EGR valve.

FIG. 5 is a graph representative of a VNT sensor impacted by a stuck EGR valve.

FIG. 6 is a graph representative of an EGR to sensor impacted by a stuck EGR valve.

FIG. 7 is a graph representative of a Diesel Particulate Filter PI sensor impacted by a stuck EGR valve.

FIG. 8 is a graph representative of the effect of a stuck EGR valve on NOx emissions.

FIG. 9 is a graph representative of the effect of a stuck EGR valve position and the ratio of the characteristic number.

FIG. 10 is a graph representative of the impact of an EGR loop leakage and NOx emissions.

FIG. 11 is a graph representative of the impact of an EGR loop leaking rate and the rate of the characteristic number.

FIG. 12 is a schematic representation of a software flow chart of one method according to the present invention.

### DETAILED DESCRIPTION OF THE PREFERRED EMBODIMENT(S)

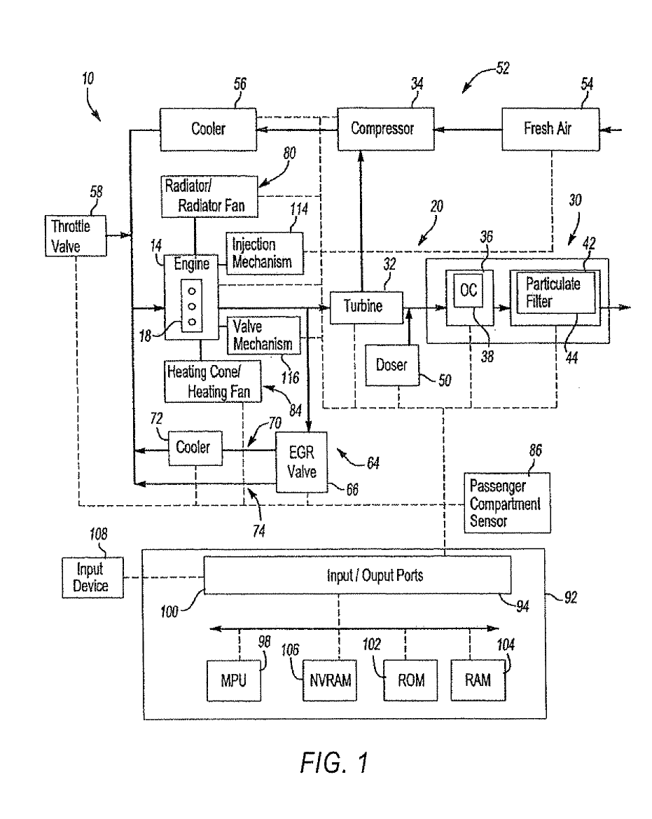

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with a spark or compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example. It should be noted, however, that the present invention is not limited to a particular type of engine or fuel.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbo compound power turbine. Of course, the present invention is not limited to exhaust systems having turbochargers or the like.

The particulate filter assembly 30 may be configured to capture particulates associated with the combustion process. In more detail, the particulate filter assembly 30 may include an oxidation catalyst (OC) canister 36, which in includes an OC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the OC canister 36 or substrate 38 and that the particulate filter 44 may be located in other portions of the exhaust system 20, such as upstream of the turbine 32.

The OC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The OC and particulate filter canisters 36, 42 may include inlets and outlets having defined cross-sectional areas with expansive portions there between to store the OC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the OC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. Optionally, the throttle intake valve 58 may also be provided to control the flow of EGR gases to the engine 14 or control both fresh air and EGR gases 64 to the engine 14. The throttle valve 58 may be a manually or electrically operated valve, such as one which is responsive to a pedal position of a throttle pedal operated by a driver of the vehicle. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming air charge and lower peak combustion temperatures to reduce the amount of oxides of nitrogen produced during combustion. The amount of exhaust gas to be recirculated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an EGR cooler 72, and an EGR cooler bypass 74. The EGR valve 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant there through. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above.

The cooling system 80 may operate in conjunction with a heating system 84. The heating system 84 may include a heating core, a heating fan, and a heater valve. The heating core may receive heated coolant fluid from the engine 14 through the heater valve so that the heating fan, which may be electrically controllable by occupants in a passenger area or cab of a vehicle, may blow air warmed by the heating core to the passengers. For example, the heating fan may be controllable at various speeds to control an amount of warmed air blown past the heating core whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

A controller 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The controller 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The system 10 may include an injection mechanism 114 for controlling fuel and/or air injection for the cylinders 18. The injection mechanism 114 may be controlled by the controller 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to the features described above.

In operation, the controller 92 receives signals from various engine/vehicle sensors and executes control logic embedded in hardware and/or software to control the system 10. The computer readable storage media may, for example, include instructions stored thereon that are executable by the controller 92 to perform methods of controlling all features and sub-systems in the system 10. The program instructions may be executed by the controller in the MPU 98 to control the various systems and subsystems of the engine and/or vehicle through the input/output ports 94. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof.

In one non-limiting aspect of the present invention, the controller 92 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system 10. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

In accordance with one non-limiting aspect of the present invention, the controller 92 or other feature, may be configured for permanently storing emission related fault codes in memory that is not accessible to unauthorized service tools. Authorized service tools may be given access by a password and in the event access is given, a log is made of the event as well as whether any changes that are attempted to made to the stored fault codes. It is contemplated that any number of faults may be stored in permanent memory, and that preferably eight such faults are stored in memory.

In sensing faults, particularly hardware failures, or impending malfunctions, it is sometimes not possible to have a physical sensor to detect the impending or actual malfunction. The present invention direct to the development of a “characteristic number”, (CN) defined as a numerical parameter calculated from more than two of the output of selected sensors through a mathematical structure as expressed below:

CN=f(sensor₁, sensor₂, . . . sensorₙ)

Those skilled in the art will recognize that a different mathematical structure defines different CN depending on the application needs. The properly defined CN can then be used as or to replace a physical measurement sensor for engine diagnostic purposes like EMD (engine manufacturer diagnostics) or OBD (on board diagnostics). When the engine is running, the calculated CN is compared to the reference value stored in the map of control software memory in real time, if the difference exceeds a threshold, a fault message is sent out.

The important concept of the CN is that it usually does not provide a meaningful physical quantity, but often a relative value related to a physical phenomena. In other words, the CN is a method that uses the sensed “effect” to track back the possible “cause”. From the engine control point of view, not all malfunctions caused by hardware failures can be detected or measured directly simply because of lack of a means of sensing them. Some malfunctions are directly measurable and detectable, but require specific physical sensors. The CN on the other hand, can provide a means to either sense the unsensable malfunctions, so to improve the protection to the engine; or replace the functionality of a physical sensor, thereby saving costs in the engine manufacturing process.

When a malfunction occurs on engine and causes a control parameter to deviate from desired target or baseline value, even without a direct measurement sensor of that control parameter, certain other sensors' readings may be affected and show a difference as compared to the normal operating baseline readings at some operating points. But these same sensors may not show the difference at other operating points. The number of sensors showing or not showing the reading difference varies with the engine's operating conditions for the same hardware malfunction. Furthermore, some sensors' readings may go both positive or negative direction in difference referring to the baseline when operating condition changes. For a sensor, even when its reading shows consistently only one direction change, the change can be caused by different reasons. If this single sensor is used to detect a hardware failure, it may give false fault. All these factors make it unreliable to use the relevant sensor's reading directly to obtain a clear picture if that specific control parameter has deviated from its target and a malfunction has occurred.

If part of all of the relevant sensors are mathematically grouped together in a proper way to form a single new parameter, the so called characteristic number CN, then the CN can carry all the information contributed by each individual sensor collectively at all operating times, and can paint a clear picture of what has happened. The proper way means that each sensor in the CN's formula reflects physical impact regarding the direction of CN's change of value. For purposes of explanation, and not in any way to be construed as limiting the invention, and as an example of this invention, the CN method may be used to replace current physical EGR flow measurement device used to monitor the EGR flow loop functionality for either insufficient flow or over flow, caused by either loop blockage or leakage in a certain range.

The first requirement is to detect a fully to partially blocked EGR loop which may cause insufficient EGR flow. The second requirement is to detect the EGR leakage from the EGR loop out to the atmosphere.

During the insufficient EGR flow engine test, the EGR valve may be locked at different positions to simulate the valve malfunction and the blockage effect of the EGR loop. The EGR loop leakage test used a by-pass valve inserted into the EGR flow pipe.

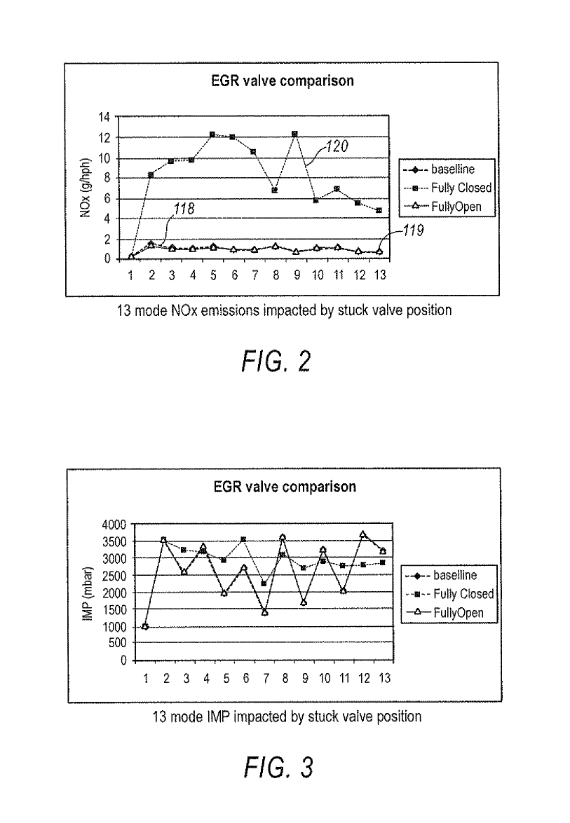

For purposes of this explanation, the identified relevant sensors affected by the stuck EGR valve position are intake manifold pressure (IMP), intake manifold temperature (IMT), turbocharger variable vane position (VNT %), EGR temperature after EGR cooler (EGR_TO), and DPF inlet pressure (DPF_IN). The results as depicted in FIGS. 2 through 11 were obtained using a Detroit Diesel Series 60® engine operated to simulate insufficient EGR flow. It is expected that similar results would be obtained operating different engines to simulate insufficient EGR flow.

FIG. 2 shows the impact of a stuck EGR valve on NOx emissions. As can be seen, compared to the baseline 118, which represents a fully open EGR valve, the fully stuck closed EGR valve 120 causing the NOx emissions to be increased significantly as the EGR flow is completely cut off. The fully stuck open valve case on the other hand, had almost no impact on NOx emissions. This is because the EGR valve is normally fully open during steady state operation. In this case, the CN method is not used to detect the fully stuck open EGR valve.

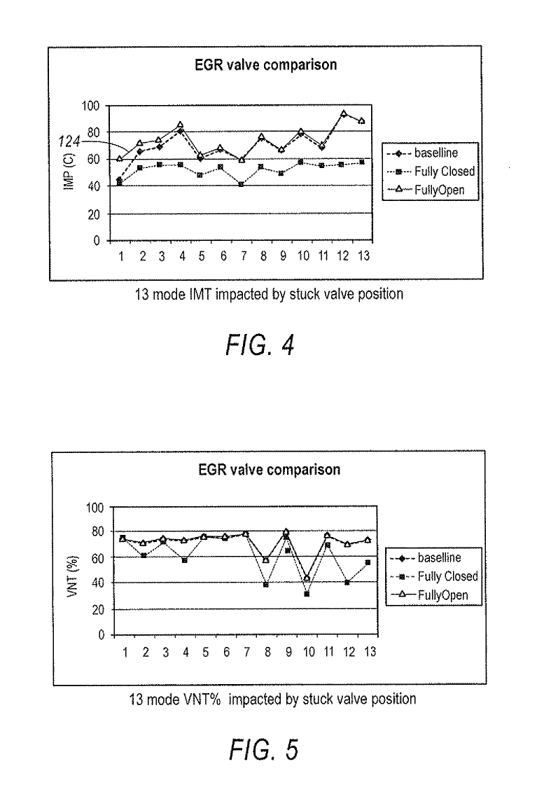

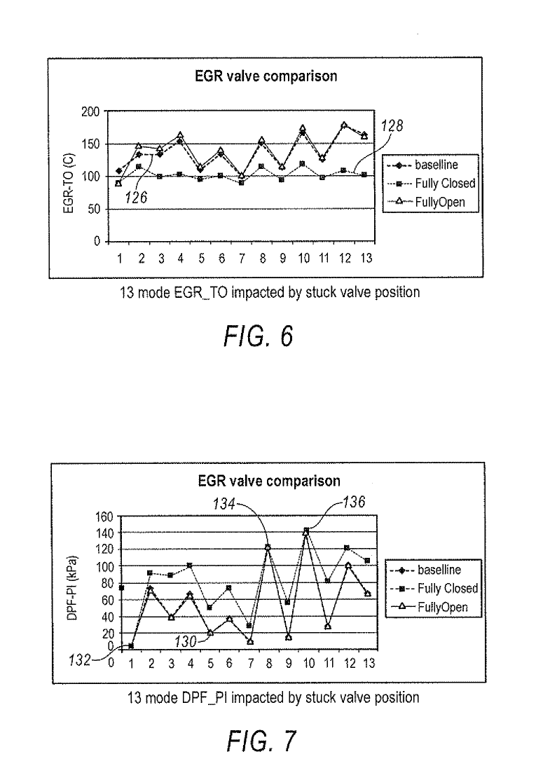

FIGS. 3 through 7 show the response of the affected sensors to the stuck EGR valve positions. As can be seen, all these sensors' readings were impacted to some extent as compared to the base line 118 and the fully closed EGR valve. As seen in FIG. 4, the baseline is slightly different that the EGR valve fully opened 124, as related to IMT. In FIGS. 3 through 7, some sensors like IMP and VNT % however, showed a difference in some modes (operating) points and did not show difference in other points. The IMP even showed both increased and decreased values in different mode points. Some sensor's readings like the IMT although showed consistent decrease for the fully stuck closed valve, the difference may not be enough to cover all the operating conditions to provide reliable detection. FIG. 6 is a graph representative of an EGR to sensor impacted by a stuck EGR valve. The Baseline 126 and fully opened EGR valve comparison are substantially similar, whereas the fully closed EGR valve position 128 is substantially different. Similarly, FIG. 7 is a graph representative of a Diesel Particulate Filter PI sensor impacted by a stuck EGR valve. Notice that at some operations the fully opened EGR valve 130 corresponds to the fully closed EGR valve 132 at data points 134 and 136.

Based on the above referenced affected sensors, the following characteristic number CN₁ was defined for detecting insufficient EGR flow:

$${CN}_{1} = \frac{( IM T ) * ( VNT \% ) * ( EGR\_TO )}{( IM P ) * ( DPF\_PI )}$$

The CN₁ now works just like a new “sensor” and its value can be used for EGR flow diagnostics. Often, the absolute value of CN₁ varies with engine operating conditions. For the convenience in calibration work, relative change of CN₁ the ratio derived from the CN₁ was used as below:

$$CN {R}_{1} = \frac{( {CN}_{1 - ref -} {CN}_{1} )}{( {CN}_{1 - ref} )}$$

Where the CN_{1-ref} is the CN₁ when the EGR loop is functioning normally.

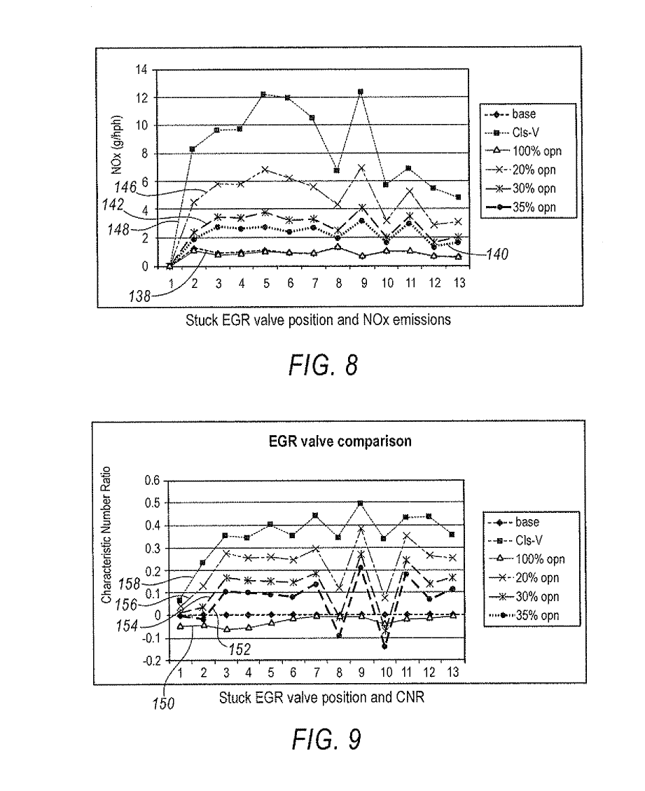

FIG. 8 shows the NOx emissions impacted by the stuck EGR valve at different positions. Baseline 138 is compared to the EGR valve fully position, which are substantially the same. When the EGR valve is 35% open as seen at 140, 30% open as seen at 142, 20% open as seen at 146 and fully closed at 148, the effect on the NOx emissions can be determined A general trend is that as the EGR is progressively closed, the amount of NOx emissions as measured in g/hph increases. Turning to FIG. 9 it can be seen that as the EGR valve position is moved from a fully opened position 150 to 35% open at 152, 30% open at 154, 20% open at 156 and fully closed, at 158, the characteristic number ratio generally increases. Thus, it can be seen that the Characteristic Number is a good indicator for EGR function.

The ratio of CN₁ or CNR₁ demonstrated good measurement capability in regard to the NOx emissions impacted by insufficient EGR flow, although not in terms of direct EGR flow rate, but more like a measurement of EGR flow “insufficiency”. A value of CNR₁ can be selected as a threshold to tell if the insufficient EGR flow condition has been met. Note that for the case where EGR valve is stuck fully open, such defined CN₁ is not able to detect as the difference of CNR₁ between the calculated and baseline (reference) is not large enough.

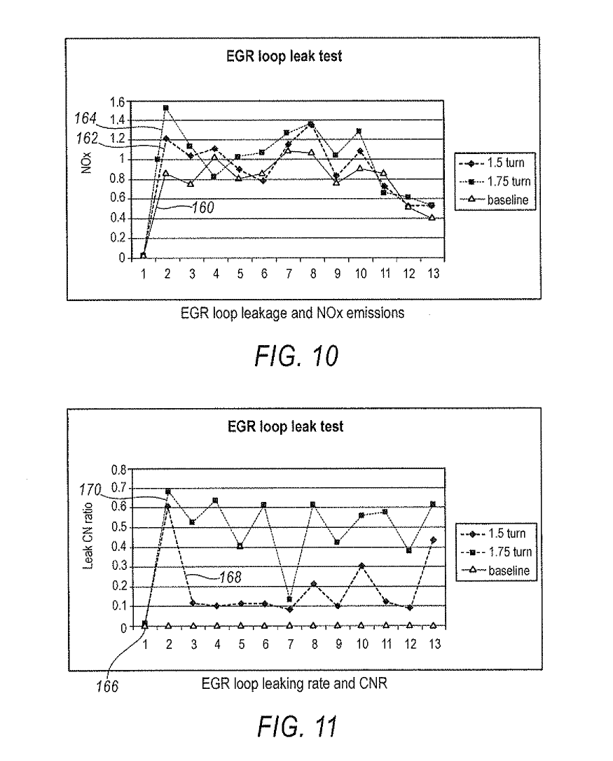

The second group of tests was conducted to check the capability of detecting EGR loop leakage. The EGR leakage rate was measured by how many turns the by-pass valve was opened, not directly the leaking flow rate measurement. Similarly, another CN₂ formed with a different number of sensors and mathematical structure was defined for EGR loop leakage detection. Again, the ratio of the CN₂ was used for calibration convenience in application. As can be seen in FIG. 10, the CN₂ ratio clearly separated the normal baseline with a leaking EGR loop and NOx emissions, although again, it could not quantify how much the leakage was, and rather is a measurement of the “severity” of leakage. In FIG. 10, the EGR loop leakage is compared to NOx emissions. The base line 160 is compared to EGR valve position 162 at 1.5 turns and with EGR valve position 164 at 1.75 turns to compare NOx emissions due to EGR position. As EGR valve position is progressively stuck open, the levels of emissions of NOx increase. FIG. 11 shows the ratio of CN₁ is correlated to the stuck EGR valve position in regard to the valve position's impact on NOx emissions. Baseline 166 is compared to EGR valve position 168 at 1.5 turns and with EGR valve position 170 at 1.75 turns. Similarly, as can be seen in FIG. 11, the CN₂ ratio clearly separated the normal baseline with a leaking EGR loop and CNR. As with FIG. 10, the CN₂ did not quantify how much the leakage was, but rather was a measurement of the “severity” of the leakage.

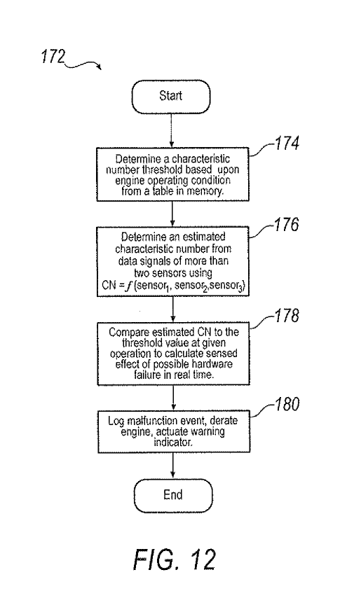

FIG. 12 is a software flow chart showing the steps for the application of the Characteristic Number Method for Engine real-time Diagnostics in an example according to one aspect of the present invention.

Specifically, method 172 is a method for real time engine diagnostics using a characteristic number to determine a severity of hardware function, and not necessarily a quantity of hardware malfunction according to one aspect of the present invention. Step 174 is determining a characteristic number threshold value based upon engine operating conditions from a table of such values in memory of an ECU. Step 176 is determining an estimated characteristic number from data signal outputs of more than two sensors through a mathematical structure: CN=f(sensor₁, sensor₂, . . . sensorₙ) wherein CN is a characteristic number and sensor₁ . . . sensorₙ are physical sensors to provide a sensed effect to track possible hardware malfunction, and step 178 is comparing the estimated CN to the threshold value at a given engine operation to calculate a sensed effect indicative of possible hardware malfunction in real time. Step 180 is log a possible hardware malfunction event, derate engine and activate warning indicator to alert operator.

The words used in the specification are understood to be words of description and not words of limitation. Those skilled in the art recognize that many variations ad modifications are possible without departing from the scope and spirit of the invention as set forth in the appended claims.

What is claimed as new and desired to be protected by Letters Patent of the United States is:

1. A method to operate an internal combustion engine equipped with an electronic control unit (ECU) having a memory, sensors in electronic communication with said electronic central unit, said method to provide real-time engine diagnostics to detect engine system hardware malfunctions, said method comprising:
determining a “characteristic number” designed for detecting a certain hardware malfunction from the data signal output of more than two sensors through a mathematical function structure:
CN f(sensor₁, sensor₂, . . . sensorₙ)
where CN is the characteristic number, and
sensor₁, sensor₂, . . . sensorₙ provide a sensed effort to track possible hardware malfunctions;
comparing the CN to the stored threshold value when the said hardware function normal to calculate a sensed effect indicative of possible hardware malfunction.

2. The method of claim 1, wherein said hardware is an engine component.

3. The method of claim 1, further including determining a relative change in CN according to the mathematical structure.
$$CN {R}_{1} = \frac{( {CN}_{1 - ref -} {CN}_{1} )}{( {CN}_{1 - ref} )}$$
where CNR₁ is relative change in CN and CN_{1-ref} is CN, when the said engine component is functioning normally.

4. The method according to claim 1, further including logging a possible hardware malfunction event, derating the engine and activating a warning alert.
